(19) United States
(12) Patent Application Publication
(10) Pub. No.: US 2024/0161648 A1
(43) Pub. Date: May 16, 2024

(54) SYSTEMS AND METHODS FOR GENERATING CUSTOMIZED LEARNING PROGRAMS

(71) Applicant: Palantir Technologies Inc., Denver, CO (US)

(72) Inventors: Anna Davies, London (GB); Benjamin Ahnert, London (GB); Bo Chen, Massy (FR); Cameron Douglas, Gayton (GB); Cathleen Jia, San Jose, CA (US); Daniel Davies, London (GB); Dominic Hillier, London (GB); Isobel Lynch, London (GB); Jason Lipowicz, London (GB); James Lowenthal, London (GB); Marvin Christopher Bornstein, London (GB); Mahmoud Ghanem, London (GB); Ranec Highet, Hertfordshire (GB); Thomas Ayles, Bermondsey (GB); Tamar Gomez, London (GB); Theo Merten-Mancer, London (GB)

(21) Appl. No.: 18/388,549

(22) Filed: Nov. 10, 2023

Related U.S. Application Data
(60) Provisional application No. 63/424,630, filed on Nov. 11, 2022.

(51) Int. Cl. G09B 7/00

(52) U.S. Cl. CPC G09B 7/00

(57) ABSTRACT

Methods and systems for generating customized learning programs include performing the operations of: receiving learning materials for a target platform; selecting a first set of learning materials based at least in part upon a first role; generating a first customized learning program which includes one or more first learning steps using the first set of learning materials; selecting a second set of learning materials based at least in part upon a second role, the second role being different from the first role, the second set of learning materials being different from the first set of learning materials; generating a second customized learning program which includes one or more second learning steps using the second set of learning materials; and deploying customized learning programs which include the first customized learning program and the second customized learning program.

### CROSS REFERENCE TO RELATED APPLICATION

This application claims priority to U.S. Provisional Application No. 63/424,630, filed Nov. 11, 2022, incorporated by reference herein in its entirety for all purposes.

### TECHNICAL FIELD

Certain embodiments of the present disclosure are directed to systems and methods for generating programs. More particularly, some embodiments of the present disclosure provide systems and methods for generating customized learning programs.

### BACKGROUND

When new members join a team, such as new employees joining a company, the on-boarding process may include the new members reviewing a set of instructions to familiarize themselves with how the team operates, for example through a series of lessons to take. However, depending upon the prior knowledge and expertise of the new members and the specific teams which they are joining, the initial touchpoint for one member may be different from that of another member. Due to such differences, each member may be required to be manually directed to the correct or appropriate instructions or lessons that match the needs of the member, which may increase the burden of the team or the person in charge of directing the new members, such as when there are many people who need to be introduced into the team.

Hence it is highly desirable to improve the techniques for generating customized learning programs for such new members.

### SUMMARY

Certain embodiments of the present disclosure are directed to systems and methods for generating programs. More particularly, some embodiments of the present disclosure provide systems and methods for generating customized learning programs.

Disclosed are methods and systems for generating customized learning programs. According to some embodiments, the method includes: receiving a plurality of learning materials for a target platform; selecting a first set of learning materials based at least in part upon a first role of a plurality of roles; generating a first customized learning program comprising one or more first learning steps using the first set of learning materials; selecting a second set of learning materials based at least in part upon a second role of the plurality of roles, the second role being different from the first role, the second set of learning materials being different from the first set of learning materials; generating a second customized learning program comprising one or more second learning steps using the second set of learning materials; and deploying a plurality of customized learning programs comprising the first customized learning program and the second customized learning program. The method is performed using one or more processors.

According to some embodiments, the system includes one or more memories having instructions stored therein and one or more processors configured to execute the instructions and perform operations. The operations include: receiving a plurality of learning materials for a target platform; selecting a first set of learning materials based at least in part upon a first role of a plurality of roles; generating a first customized learning program comprising one or more first learning steps using the first set of learning materials; selecting a second set of learning materials based at least in part upon a second role of the plurality of roles, the second role being different from the first role, the second set of learning materials being different from the first set of learning materials; generating a second customized learning program comprising one or more second learning steps using the second set of learning materials; and deploying a plurality of customized learning programs comprising the first customized learning program and the second customized learning program.

According to some embodiments, the method includes: receiving a plurality of learning materials for a target platform; for each user in a plurality of users, selecting a set of learning materials based at least in part upon a role of a plurality of roles, arranging the set of learning materials in a specific order, generating a set of verification processes based at least in part upon the set of learning materials, generating a customized learning program comprising one or more learning steps using the set of learning materials, setting one or more visibility properties of the customized learning program, creating or updating a learning program ontology associated with the customized learning program, and creating a description of the customized learning program; and deploying a plurality of customized learning programs comprising the customized learning programs generated for the plurality of users. The method is performed using one or more processors.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

The accompanying drawings are incorporated in and constitute a part of this specification and, together with the description, explain the features and principles of the disclosed embodiments. In the drawings,

FIG. 1 is a simplified diagram showing a method for generating customized learning programs according to certain embodiments of the present disclosure;

FIG. 2 is an illustrative diagram of an environment for generating customized learning programs according to certain embodiments of the present disclosure;

FIG. 3 is an illustrative diagram of a user interface of an example learning program manager according to certain embodiments of the present disclosure;

FIG. 4 is an illustrative diagram of another user interface of an example learning program manager according to certain embodiments of the present disclosure;

FIG. 5 is an illustrative diagram of an example learning program ontology according to certain embodiments of the present disclosure;

FIG. 6 is an illustrative diagram of a user interface of an example learning program builder according to certain embodiments of the present disclosure; and

FIG. 7 is a simplified diagram showing a computing system for implementing a system for generating interrelated notional data according to one embodiment of the present disclosure.

### DETAILED DESCRIPTION

Conventional systems and methods are unable to create suitable lessons or instructions for new members (hereinafter also referred to as “users”) to take or complete, as based upon the specific needs of the users. For example, the existing technology is not able to perform well at generating customized learning programs due to the different requirements for the users, for example due to the differences in teams or the different pathways which the users may take within the team after joining.

Various embodiments of the present disclosure can achieve benefits and/or improvements by a computing system incorporating processes for generating customized learning programs. In some embodiments, benefits include a straightforward system or process for providing users with custom-built training materials such as documents and videos, etc., that are suitable for the user's specific needs and requirements pertaining to the team that the user is joining, as well as to automatically track the progress of the user's training in order to monitor whether or not the users are completing the suitable training for their role in the team, for example. In some examples, the benefits include capability for super-users (e.g., managers) to hold their respective users (e.g., team members) accountable to complete their mandatory training, resulting in a higher training completion rate and a higher quality usage of the platform for the team as a whole. In some embodiments, the benefits further include providing the users with robustly and flexibly generated pathways for upskilling themselves at their positions, such as progressing from an analyst position to an application developer position and then to a data engineer position within the team such that the users can be nurtured to grow within the team using such generated learning programs that are customized accordingly. In some examples, the benefits of such flexibility and robustness include allowing the users to take self-contained lessons of higher complexity than is expected of them given their roles such that the users can grow at their own pace, as well as allowing the managers or supervisors to recognize that such users may be used in more valuable positions than they are currently placed in, even without the users manually reporting their achievements within the platform to their managers or supervisors.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

At least some embodiments of the present disclosure are directed to systems and methods for generating customized learning programs. In certain embodiments, a learning program builder, also referred to as a learning program system, is configured to generate one or more customized learning programs for a target platform (e.g., a target system, a target solution). In certain embodiments, a software system is also referred to as a software platform or a software solution, and in some cases, including hardware components supporting the execution of software. In some embodiments, the learning program builder is configured to generate one or more customized learning programs for an organization (e.g., organization-specific). In certain embodiments, the learning program builder is configured to generate one or more customized learning programs for a role (e.g., vertical-specific). In some embodiments, the learning program builder is configured to generate one or more customized learning programs for a role in an organization.

In certain embodiments, for customer-side deployment (e.g., deployment of software platforms and/or systems), the implementation team were repeatedly needing to send the same instructions to users (e.g., on-boarders) on what to read and what self-contained lessons to take. In some embodiments, the learning program builder (e.g., a learning program system) is a one-stop-shop application for the users (e.g., implementation teams, the system administrators).

In some embodiments, for customized learning programs, there is a need to hold users accountable to undertake and/or complete the programs. In certain embodiments, the customized learning programs include a mechanism that will allow super-users (e.g., managers) to hold respective users (e.g., team members) accountable to complete their mandatory training, which will result in higher training rates and higher quality usage of a target platform, also referred to as a target system or a target product. In some embodiments, the learning program builder can generate a learning program for a specific user based at least in part on their role.

In certain embodiments, the learning program builder provides a learning program management interface (e.g., a straightforward mechanism) for all users to learn more about the target platform. In some embodiments, by having a series of programs which show a clear pathway in upskilling based on roles, (e.g., from analyst moving to application developer, and moving to data engineer), the learning program builder can provide assistance in the target platform. In certain embodiments, some users may take or have taken self-contained lessons of higher complexity than might not be expected given their role, and who might have a capability to perform other roles (e.g., in more valuable positions). In some embodiments, the learning program management interface can identify those users who have taken self-contained lessons for other roles.

In certain embodiments, the learning program builder provides a governing mechanism, for example, via the learning management interface, which can be integrated with the target platform, to support organizations on training programs. In some embodiments, the learning program builder gives users a series of learning programs to complete to gain one or more skills for using the target platform. In certain embodiments, this allows the users to use an in-production target platform instance where they will have more fundamental skills allowing them to generate value faster and with less support.

According to some embodiments, the learning program builder provides users an accessible overview of the learning courses available to them on the target platform, for example, reducing time-to-value for implementation. In certain embodiments, the training programs include not only platform-wide programs (e.g., generic platform programs), but also training on organization-specific or vertical-specific workflows and applications which can be highly operational, for example, which exist only on that instance of the target platform. In some example, customers and channel partners can create and manage the learning programs themselves, for example, to create learning programs including standard platform components such as self-contained lessons and documentation links. In certain embodiments, the completion of the programs by users is flexibility verifiable by platform administrators and/or by approved platform users via the integrated platform access control model.

According to certain embodiments, the customized learning program (e.g., the learning program application) is lightweight and easy to understand at first interaction, making it simple for users to discover what they need to do and follow the process to completion. In some embodiments, the customized learning program (e.g., the learning program application) has one or more of the following features: 1) accessibility for users of one or more types (e.g., users of all types); 2) lightweight and low burden visuals; 3) rewarding and verifiable completion; 4) flexible learning program creation and delivery; and 5) push users upwards in data platform skill acquisition.

According to some embodiments, the learning program builder may create a process (e.g., a two-step process) in which a target platform can centrally deploy training programs using generic learning materials that are shipped to users (e.g., all users, tenants) that have the target platform, combined with the capability to have customized, ontology backed learning programs (e.g., displayed side-by-side). In certain embodiments, an ontology refers to a structural framework (e.g., data model) containing information and data related to objects and relationships of objects (e.g., functions applicable to objects, links) within a specific domain (e.g., an organization, an industry). In some embodiments, the ontology includes one or more processing logics applied to one or more objects (e.g., workflows). In certain embodiments, the customized learning program can be created by the implementation team and/or customers themselves via the learning program builder, for example, integrated with the target platform, with benefits that come from ontology such as access controls, metrics, ability to link to a wider ontology and/or the like.

According to certain embodiments, the learning program builder may use one or more computing models. In certain embodiments, a model includes, for example, an AI model, a machine learning (ML) model, a deep learning (DL) model, an image processing model, an algorithm, a rule, other computing models, a large language model (LLM), and/or a combination thereof. In certain embodiments, systems and methods of the present disclosure are directed to generating a text summary from one or more event logs containing unstructured and/or structured data using one or more LLMs.

According to certain embodiments, a language model is a computing model that can predict the probability of a series of words, for example, based on the text corpus on which it is trained. In some embodiments, a language model can infer word probabilities from context. In some embodiments, a language model can generate word combinations (and/or sentences) that are coherent and contextually relevant. In certain embodiments, a language model can use a computing model that has been trained to process, understand, generate, and manipulate language. In some embodiments, a language model can be useful for natural language processing, including receiving natural language prompts and providing natural language responses, speech recognition, natural language understandings, and/or the like. In certain embodiments, a language model includes an n-gram, exponential, positional, neural network, and/or other type of model.

According to some embodiments, a large language model (“LLM”) is a type of language model that has been trained on a larger data set and has a larger number of parameters (e.g., billions of parameters) compared to a regular language model. In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pre-trained Transformer 3 (GPT-3) model, a GPT 3.5-turbo model, a Claude model, a command-xlang model, a bidirectional encoder representations from transformers (BERT) model, a pathways language model (PaLM) 2, and/or the like.

In some embodiments, the learning program builder receives a prompt, uses the LLM to generate a detailed description of the program and create the program based on the

### DETAILED DESCRIPTION

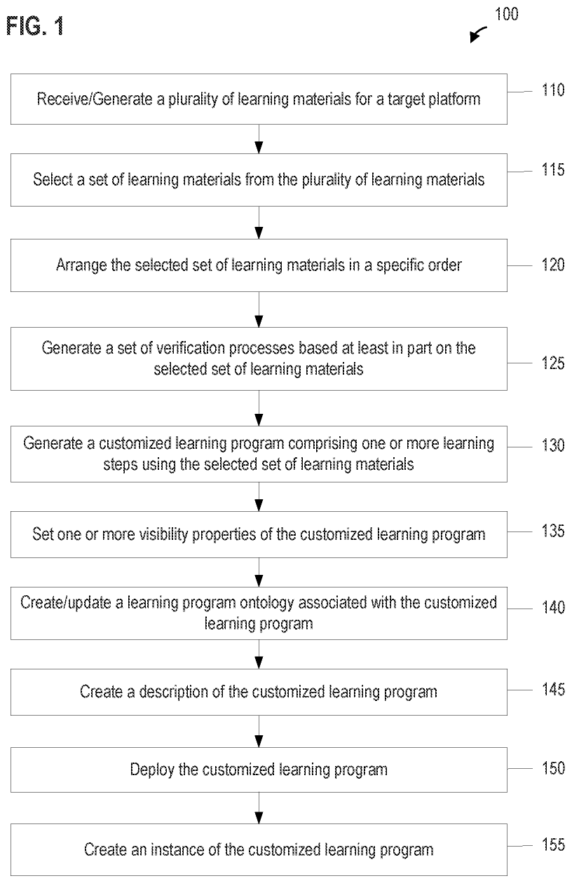

FIG. 1 is a simplified diagram showing a method 100 for generating customized learning programs according to certain embodiments of the present disclosure. This diagram is merely an example. One of ordinary skill in the art would recognize many variations, alternatives, and modifications. The method 100 for generating customized learning programs includes processes 110, 115, 120, 125, 130, 135, 140, 145, 150, and 155. Although the above has been shown using a selected group of processes for the method 100 for generating customized learning programs, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 100 are performed by the system 700. In certain examples, some or all processes (e.g., steps) of the method 100 are performed by a computer and/or a processor directed by a code. For example, a computer includes a server computer and/or a client computer (e.g., a personal computer). In some examples, some or all processes (e.g., steps) of the method 100 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, at the process 110, a learning program builder (e.g., a learning program system) is configured to receive and/or generate a plurality of learning materials for a target platform. In certain embodiments, the learning program builder is configured to create a learning material including, for example, one or more text streams (e.g., documents), videos, audio, images, and/or the like. In some embodiments, the learning program builder is configured to retrieve learning materials from a repository. In certain embodiments, the learning program builder is configured to retrieve learning materials from an external source.

According to certain embodiments, at the process 115, the learning program builder is configured to select a set of learning materials from the plurality of learning materials. In some embodiments, the learning materials are selected via a user interface. In certain embodiments, the learning materials are selected based at least in part on a user role (e.g., an operation role). In some embodiments, the learning materials are selected based at least in part on an organization property (e.g., a type of organization, a specific organization, etc.).

According to some embodiments, at the process 120, the learning program builder arranges the selected set of learning materials in a specific order. In certain embodiments, the learning program builder uses an ontology, for example, an ontology of a domain or an ontology of an organization, to determine the specific order. In some embodiments, the learning program builder is configured to determine or modify the specific order based upon inputs. In certain embodiments, the learning program builder is configured to determine or modify the specific order based upon inputs from users, for example, via a user interface. In some embodiments, the learning program builder is configured to determine or modify the specific order based upon inputs received from software interfaces (e.g., application programming interfaces (APIs), web services).

According to certain embodiments, at the process 125, the learning program builder generates a set of verification processes (e.g., quiz questions) based at least in part on the selected set of learning materials. In some embodiments, the set of verification processes include quiz questions. In certain embodiments, the quiz questions are based on extracted information from the learning materials. In some embodiments, the set of verification processes includes identified key concepts in the learning materials. In certain embodiments, the set of verification processes includes a sequence of processes, such that a verification process cannot be started before a previous verification process has been completed.

According to some embodiments, at the process 130, the learning program builder generates a customized learning program comprising one or more learning steps using the selected set of learning materials. In certain embodiments, the one or more learning steps are corresponding to one or more learning modules, where a learning module includes one or more learning materials. In some embodiments, the learning program builder arranges the selected set of learning materials according to the specific order in the customized learning program. In certain embodiments, the learning program builder generates a plurality of customized learning programs using the processes described, where a first customized learning program is for a first role of a plurality of roles (e.g., use roles, operation roles) and a second customized learning program is for a second role different from the first role. In some embodiments, the first customized learning program includes at least one learning material that is not included in the second customized learning program.

According to certain embodiments, at the process 135, the learning program builder sets one or more visibility properties of the customized learning program. In some embodiments, a visibility property indicates the customized learning program being visible and/or accessible to a group of users. In certain embodiments, a visibility property indicates an open access where the customized learning program is visible and/or accessible to all users, for example, within an instance of the target platform. In some embodiments, a visibility property indicates a restricted access where the customized learning program is visible and/or accessible to a limited number of groups of users.

According to some embodiments, at the process 140, the learning program builder creates, uses, or updates a learning program ontology associates the customized learning program. In certain embodiments, the learning program ontology includes learning program-related objects. In some embodiments, the learning program-related objects include an object type of learning material, an object type of learning program, an object type of learning program material order, an object type of learning material completion, an object type of learning program completion, and/or the like. In certain embodiments, the learning program ontology is used for progress tracking, verification, and analysis. In some embodiments, the learning program builder integrates the learning program ontology into the customized learning programs.

According to certain embodiments, the learning program builder creates a description of the customized learning program. In some embodiments, the description includes a description of one or more training materials. In certain embodiments, the description includes a description of a role. In some embodiments, the description includes a requirement for completion of the customized learning program.

According to some embodiments, at the process 150, the learning program builder deploys the customized learning program, for example, to an instance of the target platform, to a user system running an instance of the target platform. In certain embodiments, the learning program builder runs within an instance of the target platform for deploying the customized learning program. In some embodiments, after deployment, the customized learning program is integrated with the instance of target platform. In certain embodiments, the learning program builder may deploy a plurality of customized learning programs that are generated for a user and associated with a plurality of different roles within an organization. In certain examples, the learning program builder may deploy a plurality of customized learning programs that are generated for a user and associated with a plurality of different roles within a plurality of different organizations, which may have different learning program ontologies. In certain embodiments, the learning program builder may deploy a plurality of customized learning programs that are generated for a plurality of different users such that each user may be provided with a unique customized learning program.

According to certain embodiments, at the process 155, the target platform and/or the learning program builder creates an instance of the customized learning program (e.g., an academy) on the instance of the target platform. In some embodiments, the instance of the customized learning is created in response to a request of a user. In certain embodiments, the customized learning program tracks a learning progress of a user using the learning program ontology. In some embodiments, the target platform and/or the learning program builder includes a management interface to present learning progresses of one or more users.

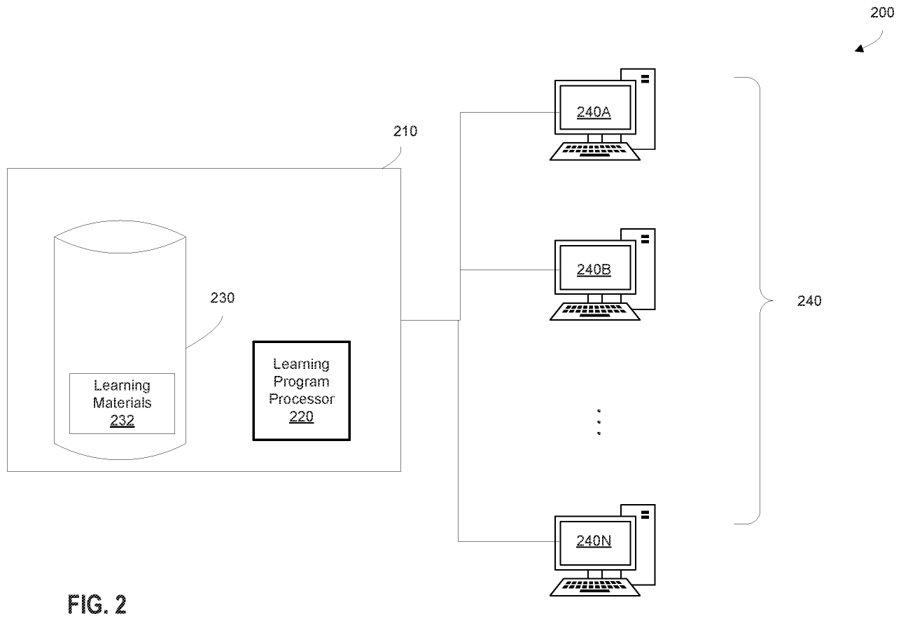

FIG. 2 is an illustrative example of a customized learning program environment 200, according to certain embodiments of the present disclosure. FIG. 2 is merely an example. One of the ordinary skilled in the art would recognize many variations, alternatives, and modifications. According to certain embodiments, the customized learning program environment 200 includes a learning program builder (e.g., a learning program system) 210 and one or more user systems 240 (e.g., user system 240A, user system 240B, . . . , user system 240N), which run one or more instances of a target platform (e.g., a target system, a target solution). In some embodiments, the learning program builder 210 runs on one or more instances of the target platform. In certain embodiments, the learning program builder 210 includes one or more learning program processors 220 and a repository 230. Although the above has been shown using a selected group of components in the customized learning program environment 200, there can be many alternatives, modifications, and variations. For example, some of the components may be expanded and/or combined. Other components may be inserted into those noted above. Depending upon the embodiment, the arrangement of components may be interchanged with others replaced. Further details of these components are found throughout the present disclosure.

According to some embodiments, the learning program builder 210 and/or the learning program processor 220 is configured to receive and/or generate a plurality of learning materials for a target platform. In certain embodiments, the learning program builder is configured to create a learning material including, for example, one or more text streams (e.g., documents), videos, audio, images, and/or the like. In some embodiments, the learning program builder is configured to retrieve (e.g., receive) learning materials from the learning material repository 232 in the repository 230. In certain embodiments, the learning program builder is configured to retrieve learning materials from an external source.

According to certain embodiments, the learning program builder 210 and/or the learning program processor 220 is configured to select a set of learning materials from the plurality of learning materials. In some embodiments, the learning materials are selected via a user interface. In certain embodiments, the learning materials are selected based at least in part on a user role (e.g., an operation role). In some embodiments, the learning materials are selected based at least in part on an organization property (e.g., a type of organization, a specific organization, etc.).

According to some embodiments, the learning program builder 210 and/or the learning program processor 220 arranges the selected set of learning materials in a specific order. In certain embodiments, the learning program builder 210 and/or the learning program processor 220 uses an ontology, for example, an ontology of a domain or an ontology of an organization, to determine the specific order. In some embodiments, the learning program builder 210 and/or the learning program processor 220 is configured to determine or modify the specific order based upon inputs. In certain embodiments, the learning program builder 210 and/or the learning program processor 220 is configured to determine or modify the specific order based upon inputs from users, for example, via a user interface. In some embodiments, the learning program builder 210 and/or the learning program processor 220 is configured to determine or modify the specific order based upon inputs received from software interfaces (e.g., application programming interfaces (APIs), web services).

According to certain embodiments, the learning program builder 210 and/or the learning program processor 220 generates a set of verification processes (e.g., quiz questions) based at least in part on the selected set of learning materials. In some embodiments, the set of verification processes include quiz questions. In certain embodiments, the quiz questions are based on extracted information from the learning materials. In some embodiments, the set of verification processes includes identified key concepts in the learning materials. In certain embodiments, the set of verification processes includes a sequence of processes, such that a verification process cannot be started before a previous verification process has been completed.

According to some embodiments, the learning program builder 210 and/or the learning program processor 220 generates a customized learning program comprising one or more learning steps using the selected set of learning materials. In certain embodiments, the one or more learning steps are corresponding to one or more learning modules, where a learning module includes one or more learning materials. In some embodiments, the learning program builder 210 and/or the learning program processor 220 arranges the selected set of learning materials according to the specific order in the customized learning program. In certain embodiments, the learning program builder 210 and/or the learning program processor 220 generates a plurality of customized learning programs using the processes described, where a first customized learning program is for a first role of a plurality of roles (e.g., use roles, operation roles) and a second customized learning program is for a second role different from the first role. In some embodiments, the first customized learning program includes at least one learning material that is not included in the second customized learning program.

According to certain embodiments, the learning program builder 210 and/or the learning program processor 220 sets one or more visibility properties of the customized learning program. In some embodiments, a visibility property indicates the customized learning program being visible and/or accessible to a group of users. In certain embodiments, a visibility property indicates an open access where the customized learning program is visible and/or accessible to all users, for example, within an instance of the target platform. In some embodiments, a visibility property indicates a restricted access where the customized learning program is visible and/or accessible to a limited number of groups of users.

According to some embodiments, the learning program builder 210 and/or the learning program processor 220 creates, uses, or updates a learning program ontology associates the customized learning program. In certain embodiments, the learning program ontology includes learning program-related objects. In some embodiments, the learning program-related objects include an object type of learning material, an object type of learning program, an object type of learning program material order, an object type of learning material completion, an object type of learning program completion, and/or the like. In certain embodiments, the learning program ontology is used for progress tracking, verification, and analysis. In some embodiments, the learning program builder 210 and/or the learning program processor 220 integrates the learning program ontology into the customized learning programs.

According to certain embodiments, the learning program builder 210 and/or the learning program processor 220 creates a description of the customized learning program. In some embodiments, the description includes a description of one or more training materials. In certain embodiments, the description includes a description of a role. In some embodiments, the description includes a requirement for completion of the customized learning program.

According to some embodiments, the learning program builder 210 and/or the learning program processor 220 deploys the customized learning program, for example, to the one or more user systems 240 running an instance of the target platform. In certain embodiments, the learning program builder 210 and/or the learning program processor 220 is integrated within the one or more user systems 240. In some embodiments, after deployment, the customized learning program is integrated with the instance of the target platform.

According to certain embodiments, the target platform run on the user system 240 and/or the learning program builder 210 creates an instance of the customized learning program (e.g., an academy) on the instance of the target platform. In some embodiments, the instance of the customized learning is created in response to a request of a user. In certain embodiments, the customized learning program tracks a learning progress of a user using the learning program ontology. In some embodiments, the target platform run on the user system 240 and/or the learning program builder 210 includes a management interface to present learning progresses of one or more users.

In some embodiments, the repository 230 can include and/or learning materials, customized learning programs, roles, organizations, ontologies, learning program ontologies, information of user systems, information of target platforms (e.g., target systems, target solutions) and/or the like. The repository 230 may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components in the customized learning program environment 200 can execute software or firmware stored in non-transitory computer-readable medium to implement various processing steps. Various components and processors of the customized learning program environment 200 can be implemented by one or more computing devices including, but not limited to, circuits, a computer, a cloud-based processing unit, a processor, a processing unit, a microprocessor, a mobile computing device, and/or a tablet computer. In some cases, various components of the customized learning program environment 200 (e.g., the learning program builder 210, the learning program processor 220, the one or more user systems 240) can be implemented on a shared computing device. Alternatively, a component of the customized learning program environment 200 can be implemented on multiple computing devices. In some implementations, various modules and components of the customized learning program environment 200 can be implemented as software, hardware, firmware, or a combination thereof. In some cases, various components of the customized learning program environment 200 can be implemented in software or firmware executed by a computing device.

Various components of the customized learning program environment 200 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

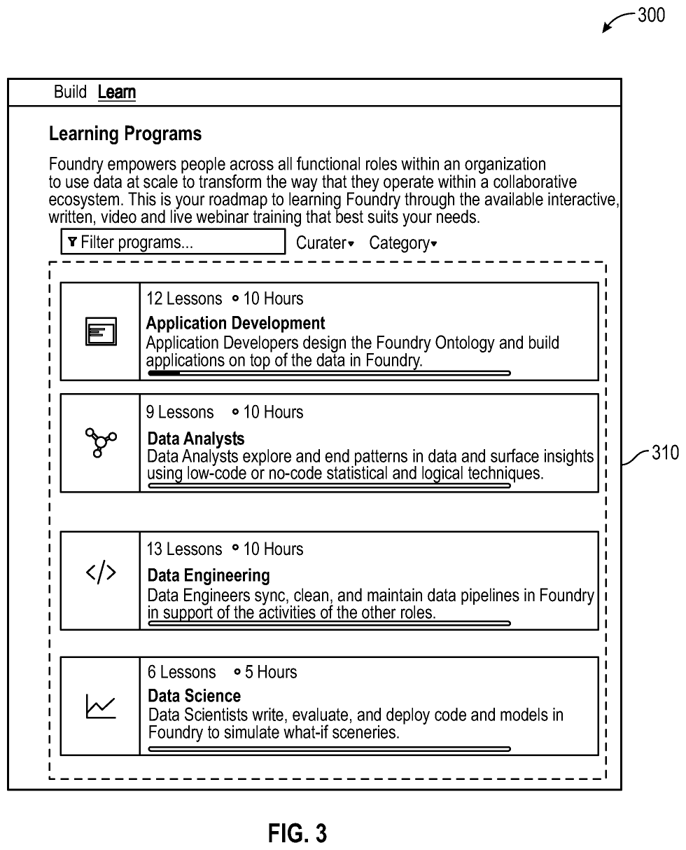

FIG. 3 is a user interface of an example learning program manager 300, according to certain embodiments of the present disclosure. FIG. 3 is merely an example. One of ordinary skill in the art would recognize many variations, alternatives, and modifications. The embodiments corresponding to FIG. 3 can be combined, modified, and/or substituted by one or more other embodiments described herein. In some embodiments, the learning program manager 300 includes a user interface to select a role and/or a workflow for generating a customized learning program. In some embodiments, the learning program manager 300 includes a user interface to select a role from one or more roles 310 and/or a workflow for accessing a customized learning program.

According to certain embodiments, a user interface of the learning program manager 300 provides access to a set of learning programs available to one or more users. In some embodiments, the learning programs are access controlled, such that the user interface presents a selected set of learning programs. In certain embodiments, the learning program manager 300 arranges an order of the selected set of learning programs based at least in part upon a role of the user and/or a login credential of the user. In some embodiments, the learning program manager 300 makes available a set of core learning programs to all users. In certain embodiments, the learning program manager 300 makes available a set of core learning programs to all users in an organization. In some embodiments, the learning program manager 300 makes available different customized learning programs to different roles (e.g., different user groups), for example, ‘application developer’ or ‘data engineering’. In certain embodiments, when a user selects a specific customized training program by a single-click.

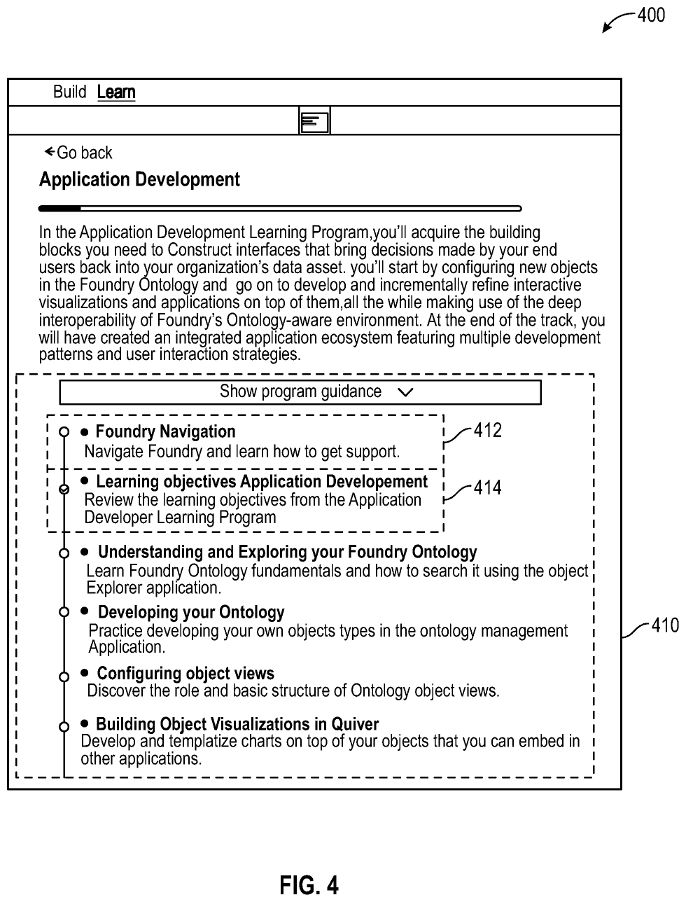

FIG. 4 is a user interface of an example customized learning program 400, according to certain embodiments of the present disclosure. FIG. 4 is merely an example. One of ordinary skill in the art would recognize many variations, alternatives, and modifications. The embodiments corresponding to FIG. 4 can be combined, modified, and/or substituted by one or more other embodiments described herein. In some embodiments, the customized learning program 400 includes a user interface to select a role and/or a workflow for generating a customized learning program. In some embodiments, the customized learning program 400 includes a user interface to select a learning step from one or more learning steps 410. In certain embodiments, each learning step 410 is associated with one or more learning materials.

According to some embodiments, the one or more learning steps 410 are arranged according to a workflow. In certain embodiments, the customized learning program includes a learning program's page directly linked to and/or enabling delivery of specific programs by emails/notifications to users. In some embodiments, if a user takes a role, the customized learning program 400 can automatically notify a user of a required program (e.g., required step). In certain embodiments, the customized learning program 400 is a lightweight application and provides accessibility. In some embodiments, the customized learning program 400 is a lightweight application and provides accessibility, for example, via linked learning materials. In certain embodiments, the customized learning program 400 is configured to display the series of learning steps 410 that need to be completed in order to finish the learning program 400. In some embodiments, the customized learning program 400 is designed to include the one or more learning steps 410 in sequence. In certain embodiments, the customized learning program 400 is designed to allow a second learning step 414 to be taken after a first step 412 has been completed.

According to certain embodiments, completion of the customized learning program 400 (e.g., an academy) is recorded automatically. In some embodiments, the customized learning program 400 can update a learning program ontology for a user (e.g., the ontology associated with a learning process of the user) of the target platform based at least in part on the learning process, for example, using data in the target platform to update the ontology. In certain embodiments, the customized learning program 400 allows a user to confirm that they have completed one or more steps, which is stored in the learning program ontology. In some embodiments, the completion of the customized learning program 400 for a user is automatically updated when the user completes all learning steps 410.

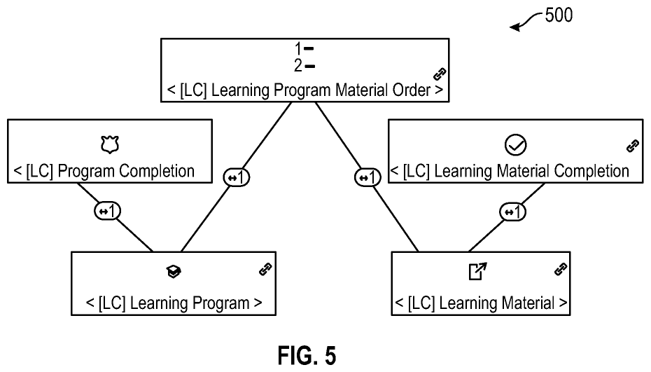

FIG. 5 is an example learning program ontology 500, according to certain embodiments of the present disclosure. FIG. 5 is merely an example. One of ordinary skill in the art would recognize many variations, alternatives, and modifications. The embodiments corresponding to FIG. 5 can be combined, modified, and/or substituted by one or more other embodiments described herein. In some embodiments, a customized learning program (e.g., the customized learning program 400 in FIG. 4) includes a learning program ontology 500.

In some embodiments, the example learning program ontology 500 includes one or more of the following objects:

In certain embodiments, “Learning Program” refers to a specific learning track including a set of learning materials in a specific order.

In some embodiments, “Learning Material” refers to specific learning content (e.g., an academy) including, for example, documentation links and/or the like. In certain embodiments, a piece of learning material which can go into multiple learning programs.

In certain embodiments, “Learning Program Material Order” refers to where a piece of learning material fits into a specific learning program.

In some embodiments, “Learning Material Completion” refers to an object to record whether a user has completed a specific learning material.

In certain embodiments, “Learning Program Completion” refers to an object to record whether a user has completed a specific learning program.

According to some embodiments, when a learning program builder creates a learning program or learning material, the learning program builder can specify its accessibility property (e.g., ‘Open’ or ‘Restricted’). In certain embodiments, an access property of ‘Restricted’ is associated with one or more specific groups with granted access. In some embodiments, an access property of ‘Restricted’ is associated with at least one group without granted access.

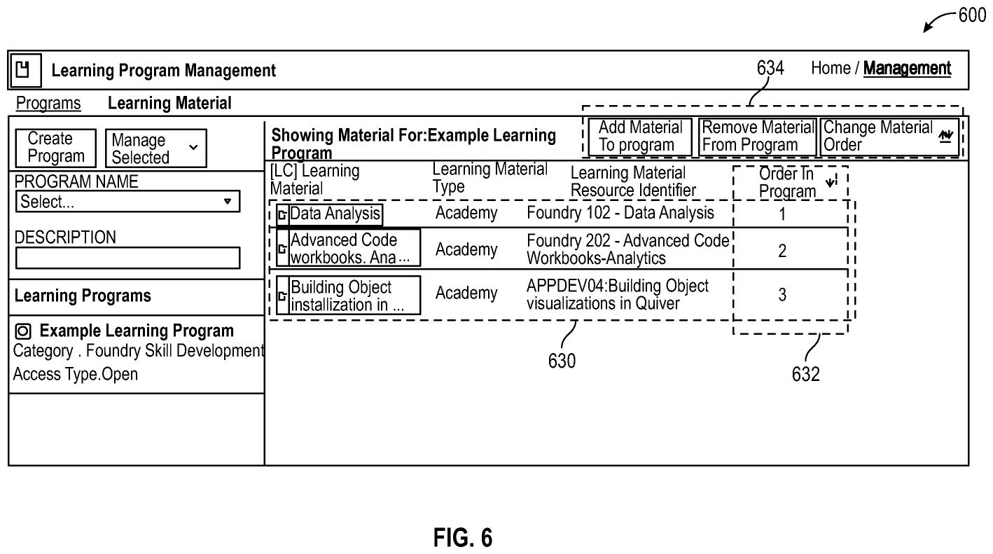

FIG. 6 is a user interface of an example learning program builder 600, according to certain embodiments of the present disclosure. FIG. 6 is merely an example. One of ordinary skill in the art would recognize many variations, alternatives, and modifications. The embodiments corresponding to FIG. 6 can be combined, modified, and/or substituted by one or more other embodiments described herein. In some embodiments, the learning program builder 600 includes a user interface to create and modify a customized learning program 630. In some embodiments, the learning program builder 600 is configured to add, modify, change order and/or delete one or more learning materials via one or more controls 634.

According to certain embodiments, the learning program builder 600 can create a new program when the pieces of learning materials are available, where each piece of learning material is a “Learning Material” object. In some embodiments, the learning program builder 600 does not allow generating duplicated pieces of learning materials. In certain embodiments, the learning program builder 600 does not allow generating duplicated pieces of learning materials based at least in part on the ontology. In some embodiments, the learning program builder 600 is configured to generate the customized learning program 630 when the specified pieces of learning materials are available and arrange the specified pieces of learning materials into a predetermined order. In certain embodiments, the learning program builder 600 can set one or more visibility properties for the customized learning program 630 for one or more groups. In some embodiments, the learning program builder 600 create a description for the customized learning program 630. In certain embodiments, the learning program builder 600 can deploy the customized learning program for use.

According to some embodiments, the learning program builder can generate a first customized learning program for a first role of a plurality of roles. In certain embodiments, the first customized learning program is an application development learning program including, for example, one or more learning materials on how to construct interfaces that bring one or more decisions (e.g., processing logics applied to one or more objects) made by one or more target platform users back into data assets (e.g., the data asserts for an organization). In some embodiments, the application development learning program includes one or more learning materials on how to configure objects (e.g., add new objects, modify objects, delete objects) in a domain ontology (e.g., an organization's ontology). In certain embodiments, the application development learning program includes one or more learning materials on how to develop and incrementally refine interactive visualizations and applications. In some embodiments, the application development learning program includes one or more learning materials on how to create an integrated application, for example, featuring multiple development patterns and user interaction strategies.

According to certain embodiments, the learning program builder can generate a second customized learning program for a second role of the plurality of roles. In some embodiments, the second customized learning program is a data analysis learning program including, for example, one or more learning materials on how to use a suite of tools and concepts to derive data-driven insights that contribute to better operational decision-making. In certain embodiments, the data analysis learning program includes one or more learning materials that do not require writing software code. In some embodiments, the data analysis learning program includes one or more advanced courses that require writing software code.

According to some embodiments, the learning program builder can generate a third customized learning program for a third role of the plurality of roles. In certain embodiments, the third customized learning program is a data engineering learning program including, for example, one or more learning materials on how to optimize the use of the target platform's infrastructure and applications to generate and maintain robust data pipelines that power operational decision-making. In some embodiments, the data engineering learning program includes one or more learning materials providing a hands-on approach to the stages of the data lifecycle and highlighting best practices for data management. In certain embodiments, the data engineering learning program includes one or more learning materials on how to use preexisting knowledge of data transform practices to use in the target platform.

According to certain embodiments, the learning program builder can generate a fourth customized learning program for a fourth role of the plurality of roles. In some embodiments, the fourth customized learning program is a data science learning program including, for example, one or more learning materials on how to discover additional modeling, machine learning, classification, and regression tools and libraries offered through multiple applications in the target platform.

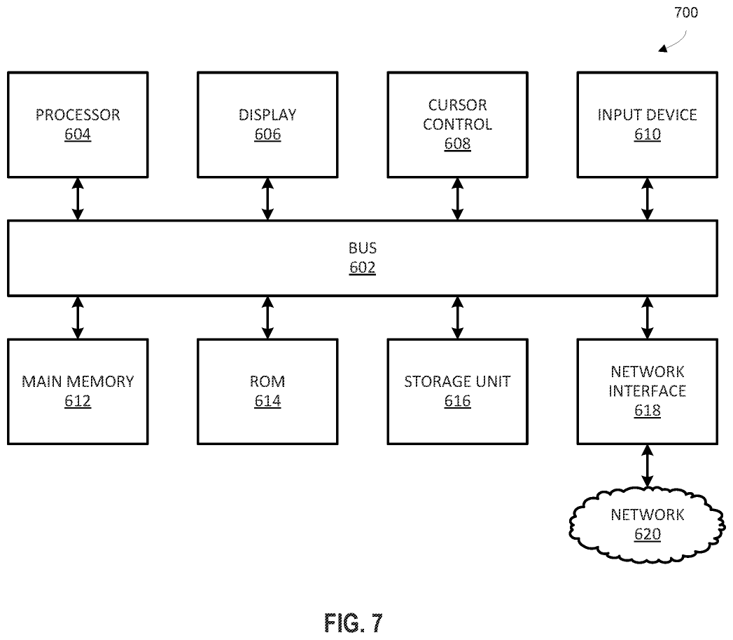

FIG. 7 is a simplified diagram showing a computing system for implementing a system 700 for generating customized learning programs in accordance with at least one example set forth in the disclosure. This diagram is merely an example, which should not unduly limit the scope of the claims. One of ordinary skill in the art would recognize many variations, alternatives, and modifications.

The computing system 700 includes a bus 602 or other communication mechanism for communicating information, a processor 604, a display 606, a cursor control component 608, an input device 610, a main memory 612, a read only memory (ROM) 614, a storage unit 616, and a network interface 618. In some embodiments, some or all processes (e.g., steps) of the method 100 are performed by the computing system 700. In some examples, the bus 602 is coupled to the processor 604, the display 606, the cursor control component 608, the input device 610, the main memory 612, the read only memory (ROM) 614, the storage unit 616, and/or the network interface 618. In certain examples, the network interface is coupled to a network 620. For example, the processor 604 includes one or more general purpose microprocessors. In some examples, the main memory 612 (e.g., random access memory (RAM), cache and/or other dynamic storage devices) is configured to store information and instructions to be executed by the processor 604. In certain examples, the main memory 612 is configured to store temporary variables or other intermediate information during execution of instructions to be executed by processor 604. For examples, the instructions, when stored in the storage unit 616 accessible to processor 604, render the computing system 700 into a special-purpose machine that is customized to perform the operations specified in the instructions. In some examples, the ROM 614 is configured to store static information and instructions for the processor 604. In certain examples, the storage unit 616 (e.g., a magnetic disk, optical disk, or flash drive) is configured to store information and instructions.

In some embodiments, the display 606 (e.g., a cathode ray tube (CRT), an LCD display, or a touch screen) is configured to display information to a user of the computing system 700. In some examples, the input device 610 (e.g., alphanumeric and other keys) is configured to communicate information and commands to the processor 604. For example, the cursor control component 608 (e.g., a mouse, a trackball, or cursor direction keys) is configured to communicate additional information and commands (e.g., to control cursor movements on the display 606) to the processor 604.

According to certain embodiments, a method for generating a plurality of customized learning programs, the method comprising: receiving a plurality of learning materials for a target platform; selecting a first set of learning materials based at least in part upon a first role of a plurality of roles; generating a first customized learning program comprising one or more first learning steps using the first set of learning materials; selecting a second set of learning materials based at least in part upon a second role of the plurality of roles, the second role being different from the first role, the second set of learning materials being different from the first set of learning materials; generating a second customized learning program comprising one or more second learning steps using the second set of learning materials; and deploying a plurality of customized learning programs comprising the first customized learning program and the second customized learning program; wherein the method is performed using one or more processors. For example, the method is implemented according to at least FIG. 1 and/or FIG. 2.

In some embodiments, the first customized learning program is generated using a first ontology associated with a first organization. In certain embodiments, the method of further comprises: selecting a third set of learning materials based at least in part upon the first role of a plurality of roles and a second ontology associated with a second organization different from the first organization; generating a third customized learning program comprising one or more third learning steps using the third set of learning materials for the first role in the second organization; selecting a fourth set of learning materials based at least in part upon the second role of the plurality of roles and the second ontology associated with the second organization, the fourth set of learning materials being different from the third set of learning materials; generating a fourth customized learning program comprising one or more fourth learning steps using the fourth set of learning materials for the first role in the second organization; and deploying, to one or more second users of the target platform in the second organization, the plurality of customized learning programs comprising the third customized learning program and the fourth customized learning program. In some embodiments, the method further comprises: generating a first set of quiz questions based at least in part upon the first set of learning materials.

In certain embodiments, the method further comprises: causing a presentation of the first set of quiz questions to a user after the user completes the first customized learning program. In some embodiments, the method further comprises: tracking a learning progress of the user based at least in part upon a response to the first set of quiz questions. In certain embodiments, the method further comprises: causing a presentation of the learning progress of the user on a management interface, the management interface includes one or more learning progresses of one or more users in a group. In some embodiments, the first customized training program includes a learning program ontology. In certain embodiments, the one or more first learning steps are in a specific order. In some embodiments, the method further comprises: setting a visibility property of the first customized learning program, where the first customized learning program is visible by a first group, where the first customized learning program is invisible by a second group different from the first group. In certain embodiments, the method further comprises: receiving a prompt; generating, using a large language model based on the prompt, a detailed description of at least one of the plurality of customized learning programs; and creating, based on the detailed description, the at least one of the plurality of customized learning programs. In some embodiments, the at least one of the plurality of customized learning programs includes the first customized learning program, the second customized learning program, the third customized learning program, and/or the fourth customized learning program.

According to certain embodiments, a system for generating a plurality of customized learning programs comprises one or more memories having instructions stored therein and one or more processors configured to execute the instructions and perform operations. The operations comprise: receiving a plurality of learning materials for a target platform; selecting a first set of learning materials based at least in part upon a first role of a plurality of roles; generating a first customized learning program comprising one or more first learning steps using the first set of learning materials; selecting a second set of learning materials based at least in part upon a second role of the plurality of roles, the second role being different from the first role, the second set of learning materials being different from the first set of learning materials; generating a second customized learning program comprising one or more second learning steps using the second set of learning materials; and deploying a plurality of customized learning programs comprising the first customized learning program and the second customized learning program. For example, the system is implemented according to at least FIG. 1, FIG. 2, and/or FIG. 7.

In some embodiments, the first customized learning program is generated using a first ontology associated with a first organization. In certain embodiments, the operations further comprise: selecting a third set of learning materials based at least in part upon the first role of a plurality of roles and a second ontology associated with a second organization different from the first organization; generating a third customized learning program comprising one or more third learning steps using the third set of learning materials for the first role in the second organization; selecting a fourth set of learning materials based at least in part upon the second role of the plurality of roles and the second ontology associated with the second organization, the fourth set of learning materials being different from the third set of learning materials; generating a fourth customized learning program comprising one or more fourth learning steps using the fourth set of learning materials for the first role in the second organization; and deploying, to one or more second users of the target platform in the second organization, the plurality of customized learning programs comprising the third customized learning program and the fourth customized learning program. In some embodiments, the operations further comprise: generating a first set of quiz questions based at least in part upon the first set of learning materials.

In certain embodiments, the operations further comprise: causing a presentation of the first set of quiz questions to a user after the user completes the first customized learning program. In some embodiments, the operations further comprise: tracking a learning progress of the user based at least in part upon a response to the first set of quiz questions. In certain embodiments, the operations further comprise: causing a presentation of the learning progress of the user on a management interface, the management interface includes one or more learning progresses of one or more users in a group. In some embodiments, the first customized training program includes a learning program ontology. In certain embodiments, the one or more first learning steps are in a specific order. In some embodiments, the operations further comprise: setting a visibility property of the first customized learning program, where the first customized learning program is visible by a first group, where the first customized learning program is invisible by a second group different from the first group. In certain embodiments, the operations further comprise: receiving a prompt; generating, using a large language model based on the prompt, a detailed description of at least one of the plurality of customized learning programs; and creating, based on the detailed description, the at least one of the plurality of customized learning programs. In some embodiments, the at least one of the plurality of customized learning programs includes the first customized learning program, the second customized learning program, the third customized learning program, and/or the fourth customized learning program.

According to certain embodiments, a method for generating a plurality of customized learning programs, the method comprising: receiving a plurality of learning materials for a target platform; for each user in a plurality of users, selecting a set of learning materials based at least in part upon a role of a plurality of roles, arranging the set of learning materials in a specific order, generating a set of verification processes based at least in part upon the set of learning materials, generating a customized learning program comprising one or more learning steps using the set of learning materials, setting one or more visibility properties of the customized learning program, creating or updating a learning program ontology associated with the customized learning program, and creating a description of the customized learning program; and deploying a plurality of customized learning programs comprising the customized learning programs generated for the plurality of users; wherein the method is performed using one or more processors. For example, the method is implemented according to at least FIG. 1 and/or FIG. 2.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for generating a plurality of customized learning programs, the method comprising:
receiving a plurality of learning materials for a target platform;
selecting a first set of learning materials based at least in part upon a first role of a plurality of roles;
generating a first customized learning program comprising one or more first learning steps using the first set of learning materials;
selecting a second set of learning materials based at least in part upon a second role of the plurality of roles, the second role being different from the first role, the second set of learning materials being different from the first set of learning materials;
generating a second customized learning program comprising one or more second learning steps using the second set of learning materials; and
deploying a plurality of customized learning programs comprising the first customized learning program and the second customized learning program;
wherein the method is performed using one or more processors.

2. The method of claim 1, wherein the first customized learning program is generated using a first ontology associated with a first organization.

3. The method of claim 2, further comprising:
selecting a third set of learning materials based at least in part upon the first role of a plurality of roles and a second ontology associated with a second organization different from the first organization;
generating a third customized learning program comprising one or more third learning steps using the third set of learning materials for the first role in the second organization;
selecting a fourth set of learning materials based at least in part upon the second role of the plurality of roles and the second ontology associated with the second organization, the fourth set of learning materials being different from the third set of learning materials;
generating a fourth customized learning program comprising one or more fourth learning steps using the fourth set of learning materials for the first role in the second organization; and
deploying, to one or more second users of the target platform in the second organization, the plurality of customized learning programs comprising the third customized learning program and the fourth customized learning program.

4. The method of claim 1, further comprising:
generating a first set of quiz questions based at least in part upon the first set of learning materials.

5. The method of claim 4, further comprising:
causing a presentation of the first set of quiz questions to a user after the user completes the first customized learning program.

6. The method of claim 5, further comprising:
tracking a learning progress of the user based at least in part upon a response to the first set of quiz questions.

7. The method of claim 6, further comprising:
causing a presentation of the learning progress of the user on a management interface, the management interface includes one or more learning progresses of one or more users in a group.

8. The method of claim 1, wherein the first customized training program includes a learning program ontology.

9. The method of claim 1, wherein the one or more first learning steps are in a specific order.

10. The method of claim 1, further comprising:
setting a visibility property of the first customized learning program;
wherein the first customized learning program is visible by a first group;
wherein the first customized learning program is invisible by a second group different from the first group.

11. The method of claim 1, further comprising:
receiving a prompt;
generating, using a large language model based on the prompt, a detailed description of at least one of the plurality of customized learning programs; and
creating, based on the detailed description, the at least one of the plurality of customized learning programs.

12. A system for generating a plurality of customized learning programs, the system comprising:
one or more memories having instructions stored therein; and
one or more processors configured to execute the instructions and perform operations comprising:
receiving a plurality of learning materials for a target platform;
selecting a first set of learning materials based at least in part upon a first role of a plurality of roles;
generating a first customized learning program comprising one or more first learning steps using the first set of learning materials;
selecting a second set of learning materials based at least in part upon a second role of the plurality of roles, the second role being different from the first role, the second set of learning materials being different from the first set of learning materials;
generating a second customized learning program comprising one or more second learning steps using the second set of learning materials; and
deploying a plurality of customized learning programs comprising the first customized learning program and the second customized learning program.

13. The system of claim 12, wherein the first customized learning program is generated using a first ontology associated with a first organization.

14. The system of claim 13, wherein the operations further comprise:
selecting a third set of learning materials based at least in part upon the first role of a plurality of roles and a second ontology associated with a second organization different from the first organization;
generating a third customized learning program comprising one or more third learning steps using the third set of learning materials for the first role in the second organization;
selecting a fourth set of learning materials based at least in part upon the second role of the plurality of roles and the second ontology associated with the second organization, the fourth set of learning materials being different from the third set of learning materials;
generating a fourth customized learning program comprising one or more fourth learning steps using the fourth set of learning materials for the first role in the second organization; and
deploying, to one or more second users of the target platform in the second organization, the plurality of customized learning programs comprising the third customized learning program and the fourth customized learning program.

15. The system of claim 12, wherein the operations further comprise:
generating a first set of quiz questions based at least in part upon the first set of learning materials.

16. The system of claim 15, wherein the operations further comprise:
causing a presentation of the first set of quiz questions to a user after the user completes the first customized learning program.

17. The system of claim 16, wherein the operations further comprise:
tracking a learning progress of the user based at least in part upon a response to the first set of quiz questions.

18. The system of claim 17, wherein the operations further comprise:
causing a presentation of the learning progress of the user on a management interface, the management interface includes one or more learning progresses of one or more users in a group.

19. The system of claim 12, wherein the operations further comprise:
setting a visibility property of the first customized learning program;
wherein the first customized learning program is visible by a first group;
wherein the first customized learning program is invisible by a second group different from the first group.

20. The system of claim 12, wherein the operations further comprise:
receiving a prompt;
generating, using a large language model based on the prompt, a detailed description of at least one of the plurality of customized learning programs; and
creating, based on the detailed description, the at least one of the plurality of customized learning programs.

21. A method for generating a plurality of customized learning programs, the method comprising:
receiving a plurality of learning materials for a target platform;
for each user in a plurality of users:
selecting a set of learning materials based at least in part upon a role of a plurality of roles,
arranging the set of learning materials in a specific order,
generating a set of verification processes based at least in part upon the set of learning materials,
generating a customized learning program comprising one or more learning steps using the set of learning materials,
setting one or more visibility properties of the customized learning program,
creating or updating a learning program ontology associated with the customized learning program, and
creating a description of the customized learning program; and
deploying a plurality of customized learning programs comprising the customized learning programs generated for the plurality of users;
wherein the method is performed using one or more processors.
